(19) United States
(12) Patent Application Publication
(10) Pub. No.: US 2025/0246715 A1
(43) Pub. Date: Jul. 31, 2025

(54) BATTERY ARRAY DESIGNS FOR IMMERSION COOLING AND VENTING SYSTEMS

(71) Applicant: FORD GLOBAL TECHNOLOGIES, LLC, Dearborn, MI (US)

(72) Inventor: Xiaogang ZHANG, Novi, MI (US)

(21) Appl. No.: 18/425,101

(22) Filed: Jan. 29, 2024

(51) Int. Cl. H01M 10/6566; H01M 10/613; H01M 10/625; H01M 10/647; H01M 10/6554; H01M 50/209; H01M 50/249; H01M 50/358

(52) U.S. Cl. CPC H01M 10/6566; H01M 10/613; H01M 10/625; H01M 10/647; H01M 10/6554; H01M 50/209; H01M 50/249; H01M 50/358; H01M 2220/20

(57) ABSTRACT

Immersion cooling and venting systems are provided for managing thermal energy levels of traction battery packs. A battery array of the traction battery pack may be configured to establish fluidly isolated cooling fluid flow paths and vent flow gas paths. A cooling fluid (e.g., a dielectric) may be communicated through the cooling fluid flow paths for immersion cooling battery cells of the battery array. The vent flow gas paths may be established by battery holders and battery stands that space the battery cells apart from a middle cooling plate of the battery array.

### TECHNICAL FIELD

This disclosure relates generally to electrified vehicle traction battery packs, and more particularly to immersion cooling and venting systems capable of managing thermal energy levels within traction battery packs.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, an array housing that provides an interior volume, a battery cell arranged within the interior volume, a middle cooling plate arranged within the interior volume and including a battery holder, and a battery stand positioned within the battery holder and configured to space the battery cell apart from the middle cooling plate, thereby establishing a vent flow gas path.

In a further non-limiting embodiment of the foregoing battery array, the middle cooling plate is arranged to subdivide the interior volume between a first interior volume section and a second interior volume section.

In a further non-limiting embodiment of either of the foregoing battery arrays, the first interior volume section extends between a bottom plate of the array housing and the middle cooling plate, and the second interior volume section extends between the middle cooling plate and a top plate of the array housing.

In a further non-limiting embodiment of any of the foregoing battery arrays, an intake runner is fluidly connected to the first interior volume section, and an exhaust runner is fluidly connected to the second interior volume section.

In a further non-limiting embodiment of any of the foregoing battery arrays, the middle cooling plate includes at least one slot that fluidly connects the first interior volume section to the second interior volume section.

In a further non-limiting embodiment of any of the foregoing battery arrays, the vent flow gas path is fluidly isolated from both the first interior volume section and the second interior volume section.

In a further non-limiting embodiment of any of the foregoing battery arrays, the battery holder includes a first wall and a second wall that protrude outwardly from an upper surface of the middle cooling plate.

In a further non-limiting embodiment of any of the foregoing battery arrays, the first wall and the second wall are established by folds formed in the middle cooling plate.

In a further non-limiting embodiment of any of the foregoing battery arrays, the battery stand is established by a second fold formed in the middle cooling plate.

In a further non-limiting embodiment of any of the foregoing battery arrays, the battery stand includes a pair of spaced apart legs that project outwardly in a direction away from a housing of the battery cell.

In a further non-limiting embodiment of any of the foregoing battery arrays, the battery stand is an integral feature of the housing.

In a further non-limiting embodiment of any of the foregoing battery arrays, the battery stand is a separate structure that is arranged between a bottom surface of the housing and an upper surface of the middle cooling plate.

In a further non-limiting embodiment of any of the foregoing battery arrays, the vent flow gas path extends between a bottom surface of the battery cell and an upper surface of the middle cooling plate, between spaced apart legs of the battery stand or between space apart walls of the battery holder, and between a first plate and a second plate of the array housing.

In a further non-limiting embodiment of any of the foregoing battery arrays, a vent gas exit pipe is mounted to the first plate or the second plate and is fluidly connected to the vent flow gas path.

In a further non-limiting embodiment of any of the foregoing battery arrays, a seal is provided at an interface between the battery holder and the battery stand.

A traction battery pack according to another exemplary aspect of the present disclosure includes, among other things, a first battery array that includes a first battery cell arranged within a first interior volume. An intake manifold is configured to receive a cooling fluid for immersion cooling the first battery cell. A first intake runner is fluidly connected to the intake manifold and the first interior volume. A first exhaust runner is fluidly connected to the first interior volume and an exhaust manifold. A first vent flow gas path is fluidly isolated from portions of the first interior volume that receive the cooling fluid. The first battery cell includes a first vent port configured to release a vent byproduct directly into the first vent flow gas path. A first vent gas exit pipe is fluidly connected to the first vent flow gas path and a vent gas manifold.

In a further non-limiting embodiment of the forgoing traction battery pack, a second battery array includes a second interior volume that is fluidly isolated from the first interior volume.

In a further non-limiting embodiment of either of the foregoing traction battery packs, a second intake runner is fluidly connected to the intake manifold and the second interior volume, and a second exhaust runner is fluidly connected to the exhaust manifold and the second interior volume.

In a further non-limiting embodiment of any of the foregoing traction battery packs, a second vent flow gas path is fluidly isolated from the portions of the first interior volume that receive the cooling fluid. A second battery cell of the first battery array includes a second vent port that is configured to release a second vent byproduct directly into the second vent flow gas path.

In a further non-limiting embodiment of any of the foregoing traction battery packs, a second vent gas exit pipe is fluidly connected to the second vent flow gas path and the vent gas manifold.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 schematically illustrates a traction battery pack equipped with an immersion cooling and venting system.

FIG. 3 illustrates an exemplary battery array of the traction battery pack of FIG. 2.

FIG. 4 is a cross-sectional view through section 4-4 of FIG. 3.

FIG. 5 is a cross-sectional view through section 5-5 of FIG. 3.

FIG. 6 illustrates another exemplary battery array.

FIG. 7 illustrates yet another exemplary battery array.

FIG. 8 illustrates select portions of a middle cooling plate of the battery array of FIG. 7.

### DETAILED DESCRIPTION

This disclosure details immersion cooling and venting systems for managing thermal energy levels of traction battery packs. A battery array of the traction battery pack may be configured to establish fluidly isolated cooling fluid flow paths and vent flow gas paths. A cooling fluid (e.g., a dielectric) may be communicated through the cooling fluid flow paths for immersion cooling battery cells of the battery array. The vent flow gas paths may be established by battery holders and battery stands that space the battery cells apart from a middle cooling plate of the battery array. These and other features are discussed in greater detail in the following paragraphs of this detailed description.

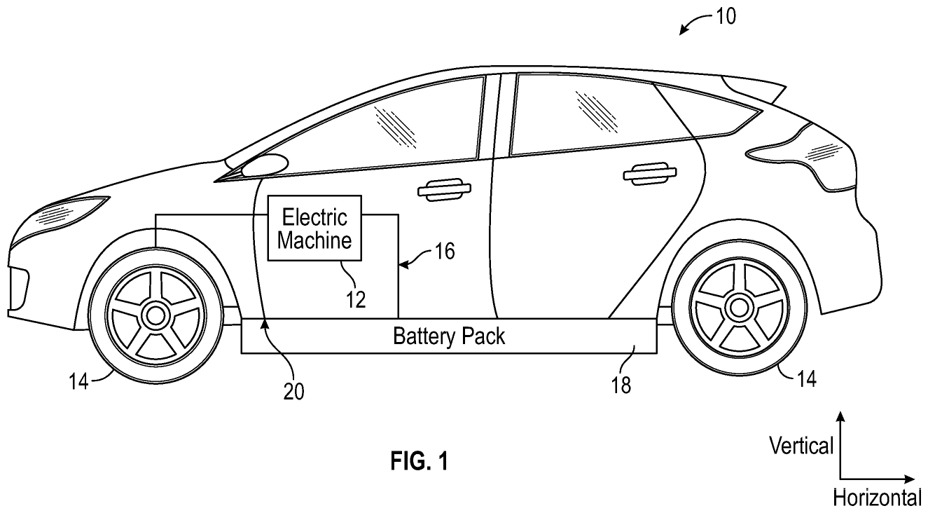

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

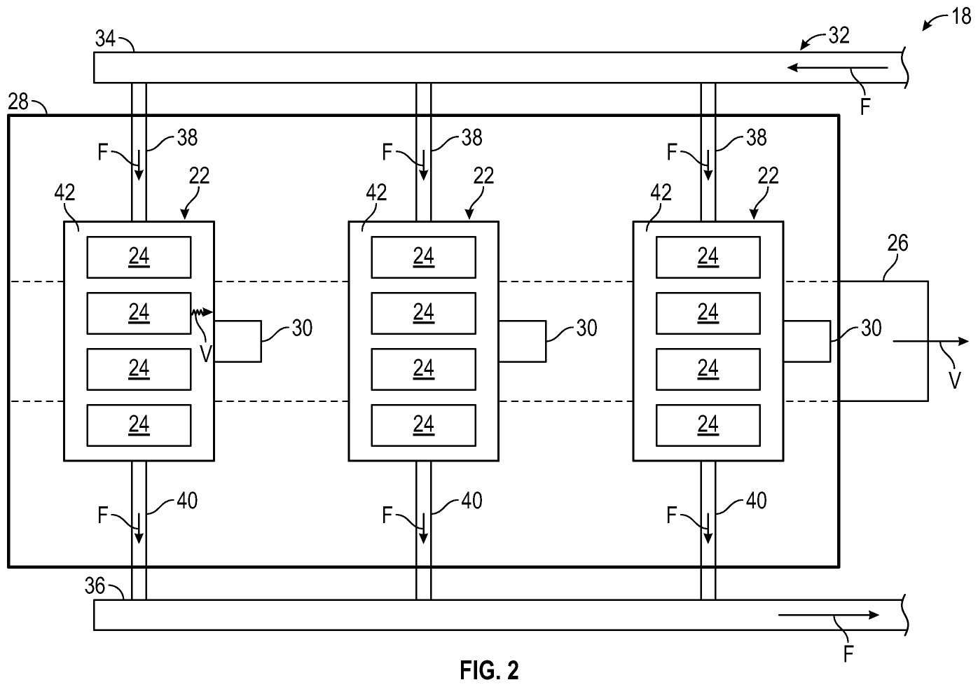

FIG. 2 illustrates additional details associated with the traction battery pack 18 of the electrified vehicle 10 of FIG. 1. The traction battery pack 18 may include a plurality of battery arrays 22 (e.g., battery modules or groupings of rechargeable battery cells 24) capable of outputting electrical power to power the electric machine 12 and/or other electrical loads of the electrified vehicle 10 for supporting electric propulsion.

The battery cells 24 may be arranged along a stack axis to construct a grouping of battery cells 24, sometimes referred to as a “cell stack.” The total number of battery arrays 22 and battery cells 24 provided within the traction battery pack 18 is not intended to limit this disclosure.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 may be arranged in on or more rows inside the traction battery pack 18. In an embodiment, the traction battery pack 18 includes three battery arrays 22, and each battery array 22 includes four battery cells 24 (for a total of twelve battery cells 24). However, other configurations are possible, and therefore the traction battery pack 18 could include a greater or fewer number of battery arrays and battery cells within the scope of this disclosure.

The battery arrays 22 and various other battery internal components (e.g., bussed electrical center, battery electric control module, wiring, connectors, etc.) may be housed inside of an enclosure assembly 28 of the traction battery pack 18. Although shown schematically, the enclosure assembly 28 could embody a single-piece design or multi-piece design (e.g., enclosure cover and enclosure tray that are joined together to establish an interior for housing the battery arrays 22). The size, shape, and overall configuration of the enclosure assembly 28 are not intended to limit this disclosure. In an embodiment, the enclosure assembly 28 provides a sealed enclosure around the battery arrays 22 and other battery internal components of the traction battery pack 18. The enclosure assembly 28 therefore provides outermost surfaces of the traction battery pack 18.

Each battery array 22 is compartmentalized and therefore fluidly isolated from the other battery arrays 22 of the traction battery pack 18. Accordingly, gases, effluent particles, and/or other vent byproducts V that could be vented by one of the battery cells 24 of one of the battery arrays 22 cannot flow directly to another of the battery arrays 22 of the traction battery pack 18.

Each battery array 22 may be spaced apart from the other battery arrays 22 of the traction battery pack 18. For example, the battery arrays 22 may be separated from one another by their respective housings. Although not specifically shown, an insulation shield could be disposed between the housings of adjacent battery arrays 22 for blocking the transfer of thermal energy from one battery array 22 to another.

The traction battery pack 18 may additionally include an immersion cooling and venting system 32. The immersion cooling and venting system 32 may provide a closed loop flow circuit for thermally managing the battery arrays 22 of the traction battery pack 18. The immersion cooling and venting system 32 may additionally provide vent gas flow paths that are fluidly isolated from the closed loop flow circuit.

The immersion cooling and venting system 32 may be configured for introducing a cooling fluid F inside each battery array 22 for directly contacting individual surfaces of the battery cells 24 with the cooling fluid F. In an embodiment, the cooling fluid F is a dielectric fluid. However, other cooling fluids could be utilized within the scope of this disclosure.

The immersion cooling and venting system 32 may include an intake manifold 34, an exhaust manifold 36, a plurality of intake runners 38, and a plurality of exhaust runners 40. The intake manifold 34 and the exhaust manifold 36 may each extend at least partially outside the enclosure assembly 28 of the traction battery pack 18, and at least a portion of the intake runners 38 and the exhaust runners 40 may extend into the interior of the enclosure assembly 28. The intake runners 38 may be fluidly connected to the intake manifold 34, and the exhaust runners 40 may be fluidly connected to the exhaust manifold 36. Each intake runner 38 and each exhaust runner 40 may further be fluidly connected to an interior volume 42 of one of the battery arrays 22.

The cooling fluid F may be selectively communicated from a reservoir (not shown) through the intake manifold 34 before being separated into the multiple intake runners 38. The cooling fluid F may then separately enter the interior volume 42 of each battery array 22 through the intake runners 38. The cooling fluid F may pick up heat from the battery cells 24 through convective heat transfer as it flows through the interior volume 42 of each battery array 22, thereby carrying away excessive heat and stabilizing the temperatures of the battery cells 24.

The cooling fluid F may exit each battery array 22 through the exhaust runners 40 before merging again within the exhaust manifold 36. The cooling fluid F may then be returned to the reservoir. Although not specifically shown in the highly schematic depiction of FIG. 2, the closed loop flow circuit of the immersion cooling and venting system 32 could additional include features such as a pump, flow control valves, sensors, controllers, etc.

One or more of the battery cells 24 packaged within the traction battery pack 18 can periodically release vent byproducts V, such as during an overcharge condition, an overdischarging condition, a short circuit, etc. The vent byproducts V can be released from the battery cells 24 through a vent port. Pressure increases within one of the battery cells 24 can cause the vent port to rupture, thereby creating a path for the vent byproducts V to be released from inside the battery cell 24.

The released vent byproducts V can be expelled from the traction battery pack 18 through a vent gas manifold 26 of the immersion cooling and venting system 32. Each battery array 22 may be fluidly connected to the vent gas manifold 26 by one or more vent gas exit pipes 30 that is/are fluidly connected to a vent gas flow path (further described below) located within the interior volume 42 of each battery array 22. The vent byproducts V can therefore travel along a vent flow path that is separate from the coolant flow path of the cooling fluid F. The cooling fluid F does not intermix with and is therefore not heated by the vent byproducts V during thermal events, thereby reducing or even eliminating convective heat transfer that could be caused by the vent byproducts V during a thermal event.

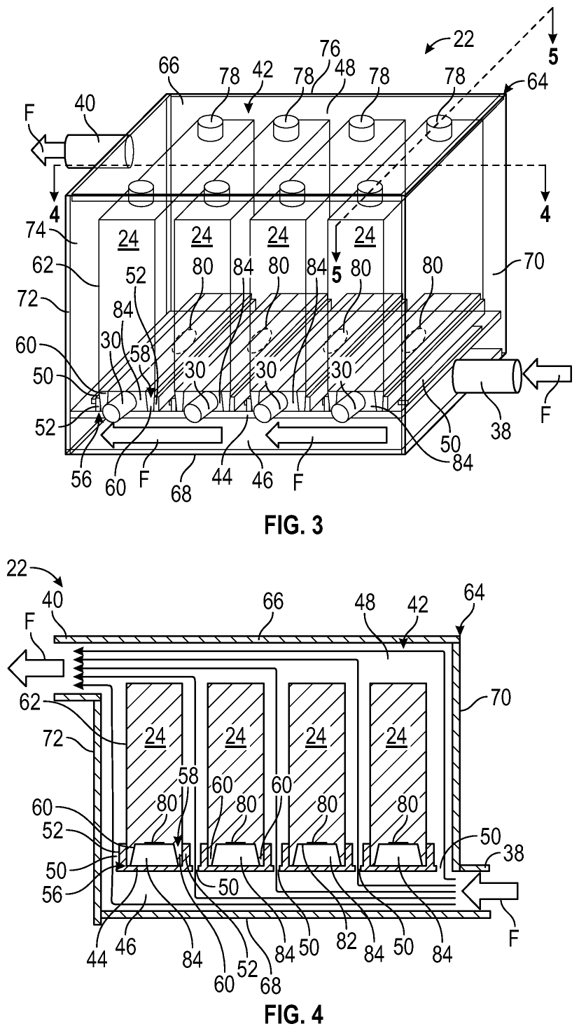

FIGS. 3, 4, and 5 illustrate an exemplary design of a battery array 22 of the traction battery pack 18 of FIGS. 1 and 2. Each battery array 22 of the traction battery pack 18 may include an identical design to the battery array 22 shown in FIG. 3, or a similar design as its electrical connections with neighboring battery arrays can vary in order to completely a necessary electrical circuit of the traction battery pack 18.

The battery array 22 includes a plurality of battery cells 24 housed within an array housing 64. The array housing 64 may be configured as a six-sided box-like structure that include a top plate 66, a bottom plate 68, a first side plate 70, a second side plate 72, a first end plate 74, and a second end plate 76. The top plate 66, the bottom plate 68, the first side plate 70, the second side plate 72, the first end plate 74, and the second end plate 76 may be connected together to establish the interior volume 42. The battery cells 24 may be positioned within the interior volume 42.

The battery cells 24 may be arranged such that major sides of the cells extend in parallel with the first and second side plates 70, 72, and minor sides of the cells extend in parallel with the first and second end plates 74, 76. The battery cells 24 may further be arranged such that terminals 78 project upwardly from an upper surface of each battery cell 24 toward the top plate 66, and a vent port 80 is provided within a bottom surface 82 of each battery cell 24 and faces downwardly toward the bottom plate 68. However, other arrangements are contemplated within the scope of this disclosure.

A middle cooling plate 44 may be arranged within the interior volume 42 at a location between one of the substituent plates of the array housing 64 and the battery cells 24. In an embodiment, the middle cooling plate 44 is positioned vertically above the bottom plate 68 of the array housing 64. However, other arrangements could be possible and are thus contemplated within the scope of this disclosure. The middle cooling plate 44 could be integrated as part of the array housing 64 or could be a completely separate structure from the array housing 64.

The middle cooling plate 44 may subdivide the interior volume 42 into a first interior volume section 46 and a second interior volume section 48. The first interior volume section 46 may extend between the bottom plate 68 and the middle cooling plate 44, and the second interior volume section 48 may extend between middle cooling plate 44 and the top plate 66. In an embodiment, the second interior volume section 48 includes a larger volume than the first interior volume section 46.

The intake runner 38 may be fluidly connected to the first interior volume section 46, and the exhaust runner 40 may be fluidly connected to the second interior volume section 48. The cooling fluid F may therefore enter the interior volume 42 within the first interior volume section 46 and may exit the interior volume 42 from the second interior volume section 48.

A plurality of slots 50 may be formed through the middle cooling plate 44 for fluidly coupling the first interior volume section 46 and the second interior volume section 48 of the interior volume 42. The slots 50 thus allow the cooling fluid F to flow from the first interior volume section 46 to the second interior volume section 48 for immersion cooling the battery cells 24. In an embodiment, one slot 50 may be provided between each adjacent pair of battery cells 24, between the first side plate 70 and one of the battery cells 24, and between the second side plate 72 and another one of the battery cells 24.

The cooling fluid F may enter the battery array 22 through the intake runner 38. The cooling fluid F may then flow across (e.g., from right to left in the illustrated embodiment) the first interior volume section 46 prior to flowing upwardly through the slots 50 and entering the second interior volume section 48. From within the second interior volume section 48, the cooling fluid F may be communicated within gaps that extend between the adjacent battery cells 24 and between the battery cells 24 and the surrounding array housing 64. The cooling fluid F can therefore sweep over and around the major and minor side surfaces of the battery cells 24 prior to exiting the second interior volume section 48 through the exhaust runner 40.

A plurality of walls 52 may protrude upwardly from an upper surface of the middle cooling plate 44. Adjacent pairs of the walls 52 may establish a battery holder 56 for receiving one of the battery cells 24. The battery holders 56 may be configured to at least partially separate the battery cells 24 from one another and retain their spaced relationship within the interior volume 42, thereby helping to establish the gaps through which the cooling fluid F may flow. One of the slots 50 of the middle cooling plate 44 may be provided between each adjacent pair of battery holders 56.

A battery stand 58 can be received within each of the battery holders 56 for spacing the battery cells 24 apart from the middle cooling plate 44. Each battery stand 58 may include a pair of spaced apart legs 60 that project in a direction away from a housing 62 of the battery cell 24. In an embodiment, the battery stand 58 is integrated as part of the housing 62 (see FIGS. 3 and 4). For example, the legs 60 could be integrated as part of a bottom surface 82 of the battery cell 24. In another embodiment, the battery stand 58 is a separate structure that can be arranged between the bottom surface 82 of the housing 62 and the middle cooling plate 44 (see FIG. 6).

Each leg 60 of the battery stand 58 may include a trapezoidal cross-sectional shape. However, other configurations are contemplated within the scope of this disclosure.

Each battery stand 58 may be positioned within one of the battery holders 56 of the middle cooling plate 44 to establish a dedicated vent gas flow path 84 for each battery cell 24 of the battery array 22. Each vent gas flow path 84 may extend between the bottom surface 82 of the battery cell 24 and the upper surface 54 of the middle cooling plate 44, between the spaced apart legs 60 of the battery stand 58, and between the first and second end plates 74, 76 of the array housing 64. Each vent gas flow path 84 is fluidly isolated from the portions of the interior volume 42 where the cooling fluid F flows. The vent gas flow paths 84 can be arranged to vent byproducts V along a venting path that is either parallel or transverse to the flow path of the cooling fluid F.

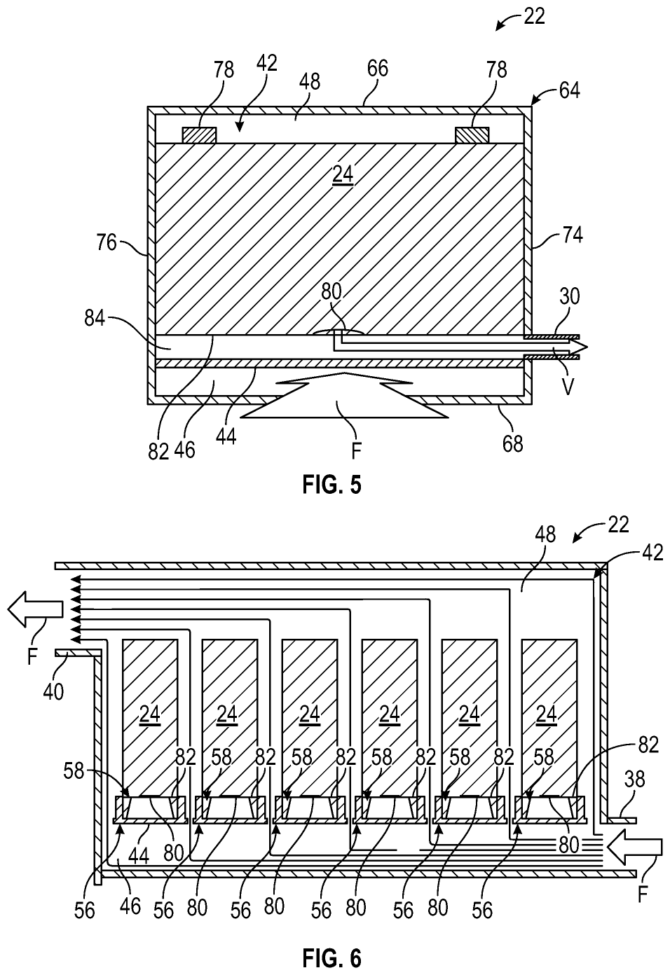

Each vent port 80 may be arranged to vent directly into the vent gas flow path 84 associated with its respective battery cell 24 during a thermal event. Once an individual battery cell 24 release vent byproducts V, the vent byproducts V may flow across the vent gas flow path 84 prior to being expelled from the battery array 22 through the vent gas exit pipe 30 (see FIG. 5). The venting battery cell 24 therefore provides little to no thermal influence on neighboring battery cells 24 of the battery array 22 during the thermal event.

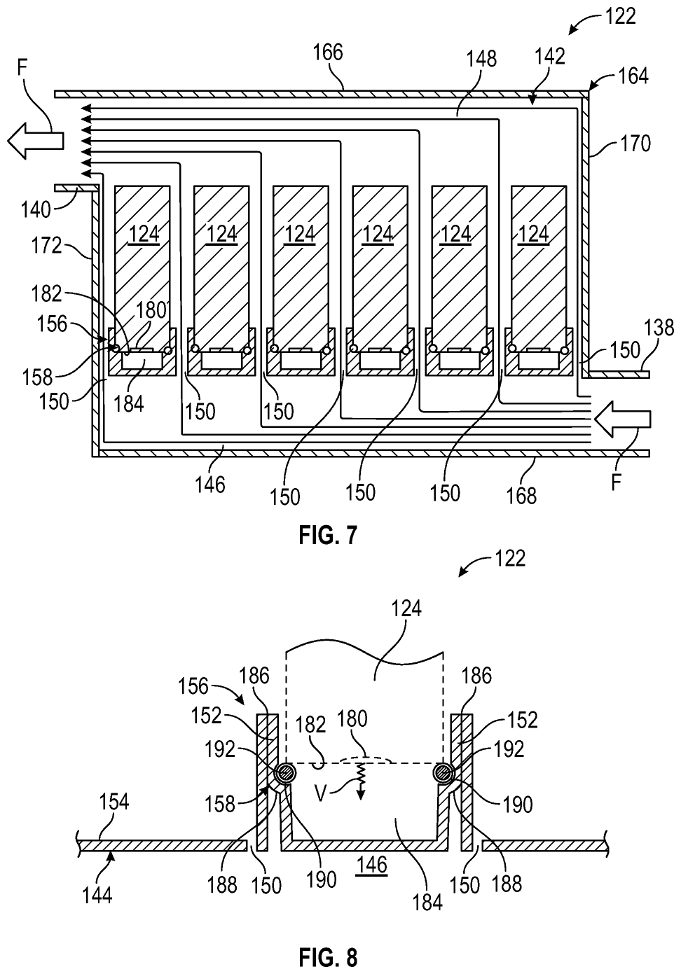

FIGS. 7 and 8 illustrate another exemplary design of a battery array 122 that can be utilized within the traction battery pack 18 of FIGS. 1 and 2. The battery array 122 is similar to the battery array 22 discussed above but includes minor modifications for providing the battery holders and the battery stands.

The battery array 122 may include a plurality of battery cells 124 housed within an interior volume 142 of an array housing 164. A middle cooling plate 144 may be arranged within the interior volume 142 at a location that is vertically above a bottom plate 168 of the array housing 164. The middle cooling plate 144 may subdivide the interior volume 142 into a first interior volume section 146 and a second interior volume section 148. The first interior volume section 146 may extend between the bottom plate 168 and the middle cooling plate 144, and the second interior volume section 148 may extend between middle cooling plate 144 and a top plate 166 of the array housing 164.

An intake runner 138 may be fluidly connected to the first interior volume section 146, and an exhaust runner 140 may be fluidly connected to the second interior volume section 148. The cooling fluid F may enter the interior volume 142 within the first interior volume section 146 and exit the interior volume 142 from the second interior volume section 148. A plurality of slots 150 may be formed through the middle cooling plate 144 for fluidly coupling the first interior volume section 146 to the second interior volume section 148 of the interior volume 142. The slots 150 thus allow the cooling fluid F to flow from the first interior volume section 146 to the second interior volume section 148 for immersion cooling the battery cells 124.

The cooling fluid F may enter the battery array 122 through the intake runner 138. The cooling fluid F may then flow across (e.g., from right to left in the illustrated embodiment) the first interior volume section 146 prior to flowing up through the slots 150 and entering the second interior volume section 148. From within the second interior volume section 148, the cooling fluid F may be communicated within gaps that extend between the adjacent battery cells 124 and between the battery cells 124 and the surrounding array housing 164 structures. The cooling fluid F can therefore sweep over and around both major and minor side surfaces of the battery cells 124 prior to exiting the second interior volume section 148 through the exhaust runner 140.

The middle cooling plate 144 may be configured to provide both a battery cell holder 156 and a battery stand 158 for receiving and maintaining a positioning of each battery cell 124 of the battery array 122. In an embodiment, the middle cooling plate 144 may be folded to form both the battery cell holder 156 and the battery stand 158. For example, first folds 186 may form walls 152 that protrude upwardly from an upper surface 154 of the middle cooling plate 144. Adjacent pairs of the walls 152 may establish the battery holders 156. Second folds 188 may be formed in the walls 152 to establish ledges 190. Adjacent pairs of the ledges 190 may establish the battery stands 158.

The battery cells 124 may be inserted into the battery holders 156 until they contact the ledges 190 of the battery stands 158. The battery stands 158 space the battery cell 124 apart from the upper surface 154 of the middle cooling plate 144, thereby establishing a dedicated vent gas flow path 184 for each battery cell 124 of the battery array 122. Each vent gas flow path 184 may extend between the bottom surface 182 of the battery cell 124 and the upper surface 154 of the middle cooling plate 144, between the walls 152 of the battery holders 156, and between plates of the array housing 164. A seal 192 may be provided at an interface between the walls 152 and the ledges 190 for sealing each vent gas flow path 184.

Each vent gas flow path 184 is fluidly isolated from the portions of the interior volume 142 where the cooling fluid F flows. The vent port 180 of each battery cell 124 may be arranged to vent into the vent gas flow path 184 associated with its respective battery cell 124 during a thermal event. Once an individual battery cell 124 release vent byproducts V, the vent byproducts V may flow through the vent gas flow path 184 prior to being expelled from the battery array 22 through a vent gas exit pipe. The venting battery cell 124 therefore provides little to no thermal influence on neighboring battery cells 124 of the battery array 122 during the thermal event.

The exemplary traction battery packs of this disclosure include an immersion cooling and venting system for providing enhanced battery cell thermal management. The battery arrays of the traction battery pack may provide a compartmentalized design that maximizes heat transfer from larger side surfaces of the battery cells. Moreover, separated vent gas flow paths of the immersion cooling and venting system limit convective heat transfer from cell-to-cell and prevent overheating of the cooling fluid.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
an array housing that provides an interior volume;
a battery cell arranged within the interior volume;
a middle cooling plate arranged within the interior volume and including a battery holder; and
a battery stand positioned within the battery holder and configured to space the battery cell apart from the middle cooling plate, thereby establishing a vent flow gas path.

2. The battery array as recited in claim 1, wherein the middle cooling plate is arranged to subdivide the interior volume between a first interior volume section and a second interior volume section.

3. The battery array as recited in claim 2, wherein the first interior volume section extends between a bottom plate of the array housing and the middle cooling plate, and the second interior volume section extends between the middle cooling plate and a top plate of the array housing.

4. The battery array as recited in claim 3, comprising an intake runner fluidly connected to the first interior volume section, and an exhaust runner fluidly connected to the second interior volume section.

5. The battery array as recited in claim 3, wherein the middle cooling plate includes at least one slot that fluidly connects the first interior volume section to the second interior volume section.

6. The battery array as recited in claim 2, wherein the vent flow gas path is fluidly isolated from both the first interior volume section and the second interior volume section.

7. The battery array as recited in claim 1, wherein the battery holder includes a first wall and a second wall that protrude outwardly from an upper surface of the middle cooling plate.

8. The battery array as recited in claim 7, wherein the first wall and the second wall are established by folds formed in the middle cooling plate.

9. The battery array as recited in claim 8, wherein the battery stand is established by a second fold formed in the middle cooling plate.

10. The battery array as recited in claim 1, wherein the battery stand includes a pair of spaced apart legs that project outwardly in a direction away from a housing of the battery cell.

11. The battery array as recited in claim 10, wherein the battery stand is an integral feature of the housing.

12. The battery array as recited in claim 10, wherein the battery stand is a separate structure that is arranged between a bottom surface of the housing and an upper surface of the middle cooling plate.

13. The battery array as recited in claim 1, wherein the vent flow gas path extends between a bottom surface of the battery cell and an upper surface of the middle cooling plate, between spaced apart legs of the battery stand or between space apart walls of the battery holder, and between a first plate and a second plate of the array housing.

14. The battery array as recited in claim 13, comprising a vent gas exit pipe that is mounted to the first plate or the second plate and is fluidly connected to the vent flow gas path.

15. The battery array as recited in claim 13, comprising a seal provided at an interface between the battery holder and the battery stand.

16. A traction battery pack, comprising:
a first battery array that includes a first battery cell arranged within a first interior volume;
an intake manifold configured to receive a cooling fluid for immersion cooling the first battery cell;
a first intake runner fluidly connected to the intake manifold and the first interior volume;
a first exhaust runner fluidly connected to the first interior volume and an exhaust manifold;
a first vent flow gas path fluidly isolated from portions of the first interior volume that receive the cooling fluid;
the first battery cell including a first vent port configured to release a vent byproduct directly into the first vent flow gas path; and
a first vent gas exit pipe fluidly connected to the first vent flow gas path and a vent gas manifold.

17. The traction battery pack as recited in claim 16, comprising a second battery array including a second interior volume that is fluidly isolated from the first interior volume.

18. The traction battery pack as recited in claim 17, comprising a second intake runner fluidly connected to the intake manifold and the second interior volume, and a second exhaust runner fluidly connected to the exhaust manifold and the second interior volume.

19. The traction battery pack as recited in claim 16, comprising a second vent flow gas path that is fluidly isolated from the portions of the first interior volume that receive the cooling fluid, wherein a second battery cell of the first battery array includes a second vent port that is configured to release a second vent byproduct directly into the second vent flow gas path.

20. The traction battery pack as recited in claim 19, comprising a second vent gas exit pipe that is fluidly connected to the second vent flow gas path and the vent gas manifold.
